(19) United States
(12) Patent Application Publication
(10) Pub. No.: US 2009/0077063 A1
(43) Pub. Date: Mar. 19, 2009

(54) Dynamic member match-making system and method thereof

(75) Inventors: Chaucer Chiu, Taipei (TW); Qi Zhang, Shanghai (CN)

Correspondence Address: BACON & THOMAS, PLLC, 625 SLATERS LANE, FOURTH FLOOR, ALEXANDRIA, VA, 22314-1176, US

(73) Assignee: INVENTEC CORPORATION, Taipei (TW)

(21) Appl. No.: 11/898,823

(22) Filed: Sep. 17, 2007

(51) Int. Cl. G06F 17/30

(52) U.S. Cl. 707/5; 707/E17.014

(57) ABSTRACT

A dynamic member match-making system and a method thereof for solving the problem that members cannot make friends with each other accurately are provided. The dynamic member match-making system collects the members' dynamic data in a time period through a dynamic information module, and then matches the members through a preset weight and selects an appropriate member to make friends, so that the members may make friends with each other more accurately and the friend-making quality is enhanced.

### BACKGROUND OF THE INVENTION

1. Field of the Invention

The present invention relates to a system and method for members to make friends with each other, and more particularly to a system and method for collecting the dynamic data of the members and selecting an appropriate member to make friends with each other.

2. Related Art

With the popularity and convenience of the Internet, network has gradually become an indispensable tool for the people in modern society, and through the Internet, the people can get to know almost everything happening around the world without leaving homes. Meanwhile, as the daily life of people in the modern society is more and more closely associated with computers and network, many people spend a lot of time in surfing the Internet, and thus, it has become a trend to make friends over Internet. Well-known chatting and friend-making services are offered by, for example, ICQ and MSN, and users can make friends with each other through such services once they are joined in to become members, and then chat with different kinds of other members and even develop friendship with them.

Although, it is a common phenomenon that the current friend-making service appears everywhere, and these services have their own unique features, however, the common chatting and friend-making service matches a user with other suitable members that meet the match-making requirements based upon the members' data submitted by the user as applying for this service, such as the constellation, blood type, age, and interests. In the prior art, the user can only make friends based upon the members' data; but the members' data can not be regularly modified and updated or supplemented. If the members' data hasn't been modified from the time that he/she submitted the data for the first time to the time that he/she is to make a friend, the data in the database for making comparison is inaccurate. As possible results, the member meeting the match-making requirements does not use this friend-making service any longer, but switches to another one; the member has changed to use another Email address instead of the original one, so the user cannot chat with this member any more and the friendship cannot be developed even if the match-making is successful; the member's interests have been changed as the time elapsed, and the member has acquired new interests and tired of the original ones, so the member's interests are somewhat different from the original ones in the basic information; and even the member's current age is greatly different from that originally submitted in the basic information, since several years have passed. However, the data in the basic information has not been modified and updated and the original age is still used for matching-make. Therefore, the problem of inaccuracy in friend-making service occurs, since no other data of the member is received and the original data is still used for match-making.

### SUMMARY OF THE INVENTION

In view of the above-mentioned problem, the present invention is directed to a dynamic member match-making system, applicable for solving the problem that the members cannot make friends with each other accurately. A dynamic information module collects dynamic data of a member, and a time period module is used for setting a time period in which the members' data are collected. Then, a weighted match-making process is performed according to a preset weight, so as to select an appropriate member to make friends with.

The dynamic member match-making system in the present invention includes a time period module, a dynamic information module, and a weighted match-making module. The time period module is used to set a time period in which the members' data are collected; the dynamic information module is used to dynamically collect external data and internal data of a member in the time period, and store the external data and internal data in a dynamic database; and the weighted match-making module is responsible for analyzing and sorting the internal data and external data and performing weighted match-making at the end of the time period, so as to select an appropriate member to make friends with.

The dynamic member match-making method in the present invention includes the following steps: first, setting a time period; then, dynamically collecting at least one external data and at least one internal data of at least one member in the time period; finally, at the end of the time period, performing the weighted match-making on the external data and the internal data of each member according to a weight unit.

Through the dynamic member match-making system and method thereof in the present invention, the members' data may be collected in the time period, so as to efficiently solve the problem that the members cannot accurately make friends with each other due to the old members' data and thus enhancing the accuracy in match-making among members.

Further scope of applicability of the present invention will become apparent from the detailed description given hereinafter. However, it should be understood that the detailed description and specific examples, while indicating preferred embodiments of the invention, are given by way of illustration only, since various changes and modifications within the spirit and scope of the invention will become apparent to those skilled in the art from this detailed description.

### BRIEF DESCRIPTION OF THE DRAWINGS

FIG. 1 is a block diagram of a dynamic member match-making system in the present invention.

FIG. 2 is a flow chart of a dynamic member match-making method in the present invention.

FIG. 3 is a schematic view of an embodiment of a selection interface in the present invention.

### DETAILED DESCRIPTION OF THE INVENTION

In order to make the present invention more comprehensible, preferred embodiments accompanied with figures are described in detail below.

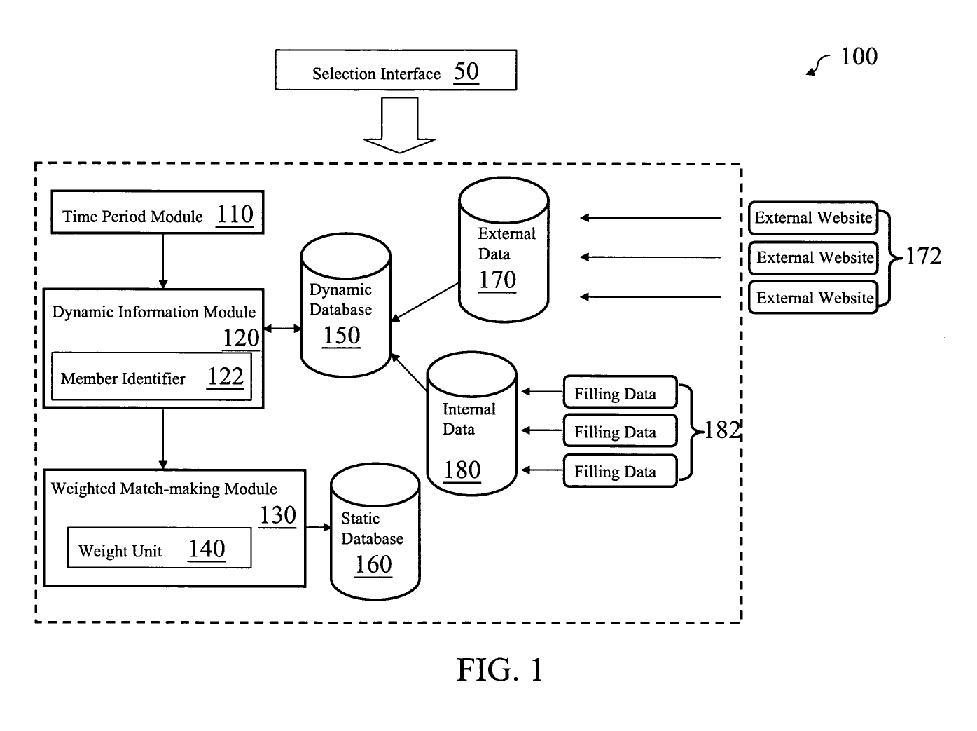

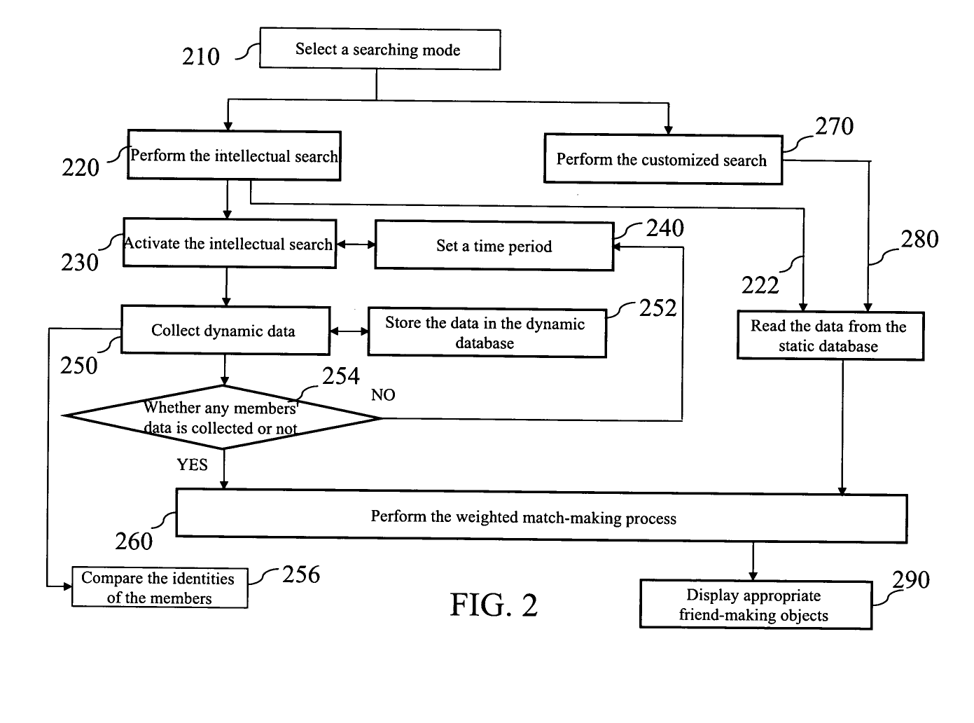

The present invention provides a dynamic member match-making system and a method thereof, which will be illustrated blow with reference to the systematic block diagram of FIG. 1 and the flow chart of FIG. 2.

In the dynamic member match-making system 100 of the present invention, a selection interface 50 is provided for a user to select a searching mode (Step 210) and to determine whether to perform an intellectual search (Step 220) or a customized search (Step 270) according to the user's selection. The intellectual search is firstly illustrated as follows.

If the user selects to perform the intellectual search from the selection interface 50 (Step 220), the function of the intellectual search is directly activated (Step 230), and at this time, a time period set by the user is firstly set in a time period module 110 (Step 240). Once the time period in the time period module 110 is determined, a dynamic information module 120 begins to collect dynamic data of members in the time period set in the time period module 110 (Step 250). If any dynamic data is collected, the dynamic information module 120 automatically stores the collected dynamic data in a dynamic database 150 (Step 252), which is used to store external data 170 and internal data 180. The external data 170 is the members' data offered by external websites 172, and the members' data offered by the external websites 172 include, but not limited to, websites without offering the same property as those friend-making services do, such as the member's favorite electronic newspapers, networks which are often browsed, favorite discussion boards, and even the member's habits in operating computers and the time for the member to browse the external websites 172, which may be set in the dynamic information module 120 depending upon actual requirements.

In the time period, as for the members' data meeting the requirements collected from the external websites 172, the dynamic information module 120 compares the identity of the member by comparing the member identifier 122 (Step 256), determines the owner of the members' data, and then transfer the data to the dynamic database 150 of the friend-making services over network. The member identifier 122 is the unique identifier generated randomly from the friend-making service to identify a member. Meanwhile as the members' data is established, the member identifier 122 is transferred to be stored in each of the external websites 172. Therefore, when the members' data transferred by the external websites 172 include the member identifier 122, the dynamic information module 120 may determines the owner of the data by comparing the member identifier 122 (Step 256), and then transfer the data to the dynamic database 150 of the friend-making services over network. For example, the member identifier 122 assigned to a user Xiaohua Lin in the friend-making service is “20070702”, so that when the dynamic information module 120 collects the members' data from the external website 172, the dynamic information module 120 confirms that all members' data with the member identifier 122 “20070702” belong to Xiaohua Lin by comparing the member identifier 122 (Step 256), and then stores the members' data into the dynamic database 150. The internal data 180 refers to the filling data 182 transferred from the friend-making service, and then transferred back to the friend-making service after being filled by the members. The filling data 182 may include, but not limited to, a member's interest amendment table, a member's mail address amendment table, a member's psychology observation station, and so on, which may be set in the dynamic information module 120 depending upon actual requirements.

In the present invention, the members' data may be collected in the time period through the external data 170 and the internal data 180, and after the time period set in the time period module 110 expires, the dynamic information module 120 determines whether the members' data have been collected or not (Step 254). If yes, the collected members' data are transferred to the weight unit 140 of the weighted match-making module 130 to perform the weighted match-making process (Step 260). The weight of the weight unit 140 is filled when the user fills the members' data, and the friend-making service assigns a percentage to the corresponding weight.

The weighted match-making module 130 activates the weight unit after reading the internal data 180 and the external data 170 in the dynamic database 150, and performs match-making on the members' data in the dynamic database 150 according to the weight set in the weight unit 140 (Step 250 and Step 252). In fact, in order to meet the basic match-making requirements of the user, the static database 160 for storing the members' basic data is also added (Step 222) to search for the friend-making objects meeting the match-making requirements through a weighting manner, and finally, the friend-making objects meeting the match-making requirements are displayed (Step 290).

However, if no members' data is collected in the time period (Step 254), the user should activate the time period module 110 through the selection interface 50 to reset a time period (Step 240). When the time period module 110 receives the new time period, the dynamic information module 120 is activated again (Step 230 and Step 250), so as to continue the weighted match-making process (Step 260).

As for the other choice of the user, if the user does not want to select the intellectual search, the present invention also retains the conventional searching and match-making method, i.e., the user may select the customized search from the provided selection interface 50 (Step 270). In fact, the customized search is to perform the weighted match-making (Step 260) according to the basic data filled by the user and stored in the static database 160 (Step 280), and meanwhile, the base data of the members are read from the static database 160 through the weight unit 140 in the weighted match-making module 130, so as to perform the weighted match-making (Step 260), and find appropriate friend-making objects according to the sequence of the weights set by the user from high to low. The customized search, as an additional match-making choice, mainly aims at offering a habitual match-making mechanism to the user.

Through the dynamic member match-making system and the method thereof, the members' data may be collected in the time period, so as to solve the problem that the members cannot accurately make friends due to the old members' data and thus enhancing the match-making accuracy.

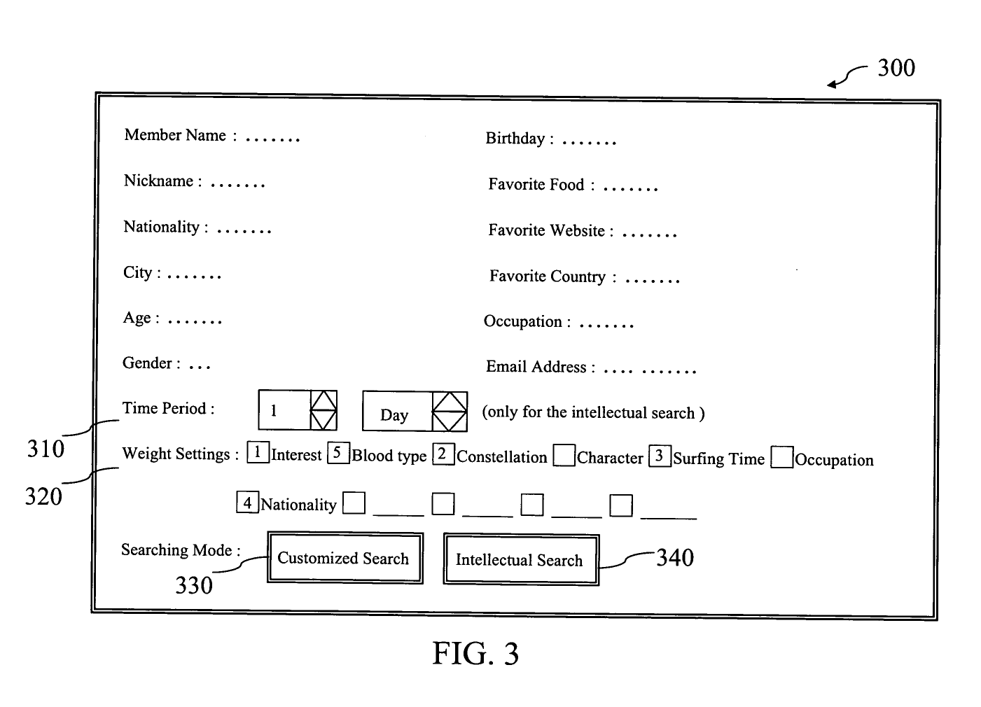

FIG. 3 is a schematic view of an embodiment of the selection interface 50 in the present invention, which is used to illustrate the basic data that must be filled by the user before using the friend-making service. The selection interface 50 herein is merely intended to demonstrate an embodiment, but not to limit the aspect of the selection interface 50 in the present invention. For example, in the part of setting the weight, after the user selects a weight, detailed items (not shown) will be additionally provided for the user to select. Provided that the user firstly selects the Occupation as a weight 1, it indicates that the weight of the occupation is the highest. Subsequently, other windows may be designed and popped up for being further filled by the user (for example, the detailed items of the Occupation for the user to fill in include doctor, lawyer, or teacher). If the Character is selected as a weight 2, it indicates that the weight of the Character is the second highest, and so forth.

In the part of the searching mode, the user may select the customized search 330 or the intellectual search 340. If the customized search 330 is selected, in this embodiment, according to the weight settings 320 selected by the user about the weights of interest, constellation, surfing time, nationality, and blood type from high to low, the friend-making service assigns a corresponding weight unit 140, that is, weights of 100%, 90%, 80%, 70%, and 60%. In the present invention, the percentage for each item in the weight unit 140 can be adjusted depending upon actual requirements, and then the weighted match-making module 130 is used to find the appropriate friend-making objects from the static database 160 according to the weight settings 320 from high to low, and meanwhile, the user may determine the number of the appropriate friend-making objects to be output and the information to be displayed.

For example, in this embodiment, if the user selects the intellectual search 340, the time period 310 should be set, and the time period set by the user is one day. Meanwhile, the weight settings 320 selected by the user include the weights of the interest, constellation, surfing time, nationality, and blood type from high to low, and the system assigns the corresponding weight percentage as 100%, 90%, 80%, 70%, and 60% in the weight unit 140. Of course, the system is capable of adjusting the percentage depending upon actual requirements, and activating the dynamic information module 120. Therefore, in this time period of one day, the dynamic information module 120 collects the external data 170 of the members from the external websites 172 in cooperation with the friend-making service, such as Google, astrology.yahoo.com, and the discussion boards of Photograph BBS. Meanwhile, the dynamic information module 120 also transfers the filling data 182 of the internal data 180 through the friend-making service, for example, the mood index, psychological test, and questionnaire, for the members to fill in. Then, the collected external data 170 and the internal data 180 are stored in the dynamic database 150 to be used by the weighted match-making process. Since the collected dynamic data is the data of the member and the weighted match-making module 130 is further used, appropriate friend-making objects can be found from the dynamic database and the static database after sorting and analyzing. If no members' data are collected in the whole day, the time period should be reset and the dynamic information module 120 should be activated again, thereby continuing the weighted match-making procedures (Step 260).

The invention being thus described, it will be obvious that the same may be varied in many ways. Such variations are not to be regarded as a departure from the spirit and scope of the invention, and all such modifications as would be obvious to one skilled in the art are intended to be included within the scope of the following claims.

What is claimed is:

1. A dynamic member match-making system, capable of providing an intellectual search to search for a friend-making object, comprising:
a time period module, for setting a time period;
a dynamic information module, for dynamically collecting at least one external data and at least one internal data of at least one member in the time period, and storing the external data and the internal data into a dynamic database; and
a weighted match-making module, for activating a weight unit at the end of the time period, and performing weighted match-making on the external data and the internal data of each of the members according to the weight of the weight unit.

2. The dynamic member match-making system as claimed in claim 1, wherein the external data is the data of the members on external websites; and the internal data is the data filled by the members in the dynamic member match-making system.

3. The dynamic member match-making system as claimed in claim 1, wherein the dynamic information module further comprises a member identifier for comparing identities of the members once the external data are collected.

4. The dynamic member match-making system as claimed in claim 1, further comprising a static database for storing the members' basic data and providing the members' basic data for the weighted match-making module to search for friend-making objects meeting match-making requirements through a weighting manner in accordance with the external data and the internal data.

5. The dynamic member match-making system as claimed in claim 1, wherein the weight unit comprises preset weights for the external data and the internal data.

6. The dynamic member match-making system as claimed in claim 1, further comprising a selection interface, provided for a user to set the member's basic data, the time period, and the weight, and provided for the user to select a customized search or an intellectual search.

7. The dynamic member match-making system as claimed in claim 6, wherein the customized search is used to search for a friend-making object meeting match-making requirements based on the user's basic data through a weighting manner.

8. The dynamic member match-making system as claimed in claim 1, further comprising a display module for outputting friend-making objects meeting the user's searching and match-making requirements.

9. The dynamic member match-making system as claimed in claim 1, wherein the dynamic information module activates the time period module via the selection interface to reset the time period if no members' external data and internal data are collected at the end of the time period, and then the dynamic information module is activated to dynamically collect the external data and the internal data once again.

10. A dynamic member match-making method, capable of providing an intellectual search to search for a friend-making object, comprising:
setting a time period;
dynamically collecting at least one external data and at least one internal data of at least one member in the time period, and storing the external data and the internal data in a dynamic database; and
at the end of the time period, performing weighted match-making on the external data and the internal data of each of the members according to a weight unit.

11. The dynamic member match-making method as claimed in claim 10, further comprising comparing identities of the members by using a member identifier once the external data is collected.

12. The dynamic member match-making method as claimed in claim 10, further comprising a step of storing the members' basic data and providing the members' basic data for the weighted match-making module to search for friend-making objects meeting match-making requirements through a weighting manner in accordance with the external data and the internal data.

13. The dynamic member match-making method as claimed in claim 10, wherein the weight unit comprises preset weights for the external data and the internal data.

14. The dynamic member match-making method as claimed in claim 10, further comprising a step of enabling a user to set the basic data, the time period, and the weight, and to select a customized search or the intellectual search.

15. The dynamic member match-making method as claimed in claim 14, wherein the customized search is used to search for friend-making objects meeting match-making requirements based on the user's basic data through a weighting manner.

16. The dynamic member match-making method as claimed in claim 10, further comprising a step of selecting the intellectual search to reset a time period if no members' external data and internal data are collected at the end of the time period, and then dynamically collecting the external data and the internal data once again.
